(19) United States
(12) Patent Application Publication
(10) Pub. No.: US 2021/0372285 A1
(43) Pub. Date: Dec. 2, 2021

(54) SEGMENT FOR A TURBINE ROTOR STAGE

(71) Applicant: Siemens Aktiengesellschaft, München (DE)

(72) Inventors: Jan H. Marsh, Orlando, FL (US); Evan C. Landrum, Charlotte, NC (US)

(21) Appl. No.: 16/322,678

(22) PCT Filed: Aug. 30, 2016
(86) PCT No.: PCT/US2016/049382

§ 371 Date: Feb. 1, 2019

(51) Int. Cl. F01D 5/14; F01D 5/18; F01D 5/28

(52) U.S. Cl. CPC F01D 5/146; F01D 5/181; F01D 5/282; F01D 5/187; F05D 2240/306; F05D 2240/301; F05D 2260/202; F05D 2300/6033; F05D 2240/305; F01D 5/284

(57) ABSTRACT

A rotor stage (10) of a turbine engine includes a circumferential row of rotor segments (12), each including: first and second endwalls (14, 16) spaced apart radially, and a first and second sidewalls (18, 20) extending radially between the first and second endwalls (14, 16) and spaced apart circumferentially. The first and second endwalls (14, 16) and the first and second sidewalls (18, 20) define therewithin a flow passage (22) for hot gas. Circumferentially adjacent segments (12a, 12b) mate along a respective split-line (24) extending along an interface between the first sidewall (18) of a first segment (12a) and the second sidewall (20) of a second circumferentially adjacent segment (12b). A composite airfoil structure (26) is thereby defined having a pressure sidewall (18) formed by the first sidewall (18) of the segment (12a) and a suction sidewall (20) formed by the second sidewall (20) of the second segment (12b). The first and second endwalls (14, 16) are respectively configured as a platform (14) and a tip shroud (16) of the segment (12).

### BACKGROUND

### 1. Field

The present invention is directed generally to gas turbine engines, and more particularly to a segment of a turbine rotor stage.

### 2. Description of the Related Art

In a turbomachine, such as a gas turbine engine, air is pressurized in a compressor section and then mixed with fuel and burned in a combustor section to generate hot combustion gases. The hot combustion gases are expanded within a turbine section of the engine where energy is extracted to power the compressor section and to produce useful work, such as turning a generator to produce electricity. The hot combustion gases travel through a series of turbine stages within the turbine section. A turbine stator stage may include a row of stationary airfoils, i.e., stator vanes, which direct the hot combustion gases to a turbine rotor stage comprising a row of rotating airfoils, i.e., rotor blades. The rotor blades extract energy from the hot combustion gases for providing output power. Since stator vanes and rotor blades are directly exposed to the hot combustion gases, they are typically provided with internal cooling channels. The internal cooling channels conduct a coolant, typically air bled from the compressor section, to absorb heat from the airfoil structure, especially the airfoil outer wall which is directly exposed to the hot combustion gases.

In order to push gas turbine efficiencies even higher, there is a continuing drive to reduce coolant consumption in the turbine. For example, it is known to form turbine blades and vanes of ceramic matrix composite (CMC) materials, which have higher temperature capabilities than conventional superalloys. Since a CMC vane or a blade is capable of operating at higher temperatures than conventional airfoils, it is possible to reduce consumption of compressor air for cooling purposes.

### SUMMARY

Briefly, aspects of the present invention provide an alternate configuration of a segment for a turbine rotor stage.

According a first aspect of the present invention, a rotor stage of a turbine engine is provided. The rotor stage comprises a circumferential row of rotor segments each segment comprising: first and second endwalls extending in a circumferential direction and spaced apart in a radial direction in relation to an axis of the turbine engine. The first endwall is configured as a platform of the segment and the second endwall is configured as a tip shroud of the segment. The segment further comprises first and second sidewalls spaced apart in the circumferential direction and extending radially between the first and second endwalls. The first and second endwalls and the first and second sidewalls define therewithin a flow passage for a hot gas. Circumferentially adjacent segments mate along a respective split-line which extends along an interface between the first sidewall of a first segment and the second sidewall of a second circumferentially adjacent segment, to form composite airfoil structure. The composite airfoil structure comprises a pressure sidewall formed by the first sidewall of the first segment and a suction sidewall formed by the second sidewall of the second segment. The pressure and suction sidewalls of the airfoil structure extend between a leading edge and a trailing edge of the airfoil structure.

According a second aspect of the present invention, a segment of a turbine rotor stage is provided. The segment comprises first and second endwalls extending in a circumferential direction and spaced apart in a radial direction in relation to an axis of the turbine engine. The first endwall is configured as a platform of the segment and the second endwall is configured as a tip shroud of the segment. The segment further comprises first and second sidewalls spaced apart in the circumferential direction and extending radially between the first and second endwalls. The first and second endwalls and the first and second sidewalls define therewithin a flow passage for a hot gas. The respective segment is configured to mate with circumferentially adjacent segment on either side along a respective split line, such that each split-line extends along an interface between one of the first or second sidewalls of the respective segment and a corresponding other of the first or second sidewalls of the circumferentially adjacent segment on either side.

### BRIEF DESCRIPTION OF THE DRAWINGS

The invention is shown in more detail by help of figures. The figures show preferred configurations and do not limit the scope of the invention.

FIG. 1 illustrates a standard rotor blade assembly, looking axially in the direction of flow of a hot gas;

FIG. 2 is a radial cross-sectional view along the section line II-II in FIG. 1;

FIG. 3 illustrates a rotor segment assembly in accordance with one embodiment of the present invention, looking axially in the direction of flow of a hot gas;

FIG. 4 is a radial cross-sectional view along the section line IV-IV in FIG. 3;

FIG. 5 is a longitudinal side view of a rotor segment shown in FIG. 3;

FIG. 6 is a radial cross-sectional view of a rotor segment according to a second embodiment of the present invention; and

FIGS. 7-11 illustrate multiple embodiments of the present invention depicting different configurations of the split-line between circumferentially adjacent rotor segments.

### DETAILED DESCRIPTION

In the following detailed description of the preferred embodiments, reference is made to the accompanying drawings that form a part hereof, and in which is shown by way of illustration, and not by way of limitation, a specific embodiment in which the invention may be practiced. It is to be understood that other embodiments may be utilized and that changes may be made without departing from the spirit and scope of the present invention.

In the drawings, the direction A denotes an axial direction parallel to an axis of the turbine engine, while the directions R and C respectively denote a radial direction and a circumferential direction with respect to said axis of the turbine engine.

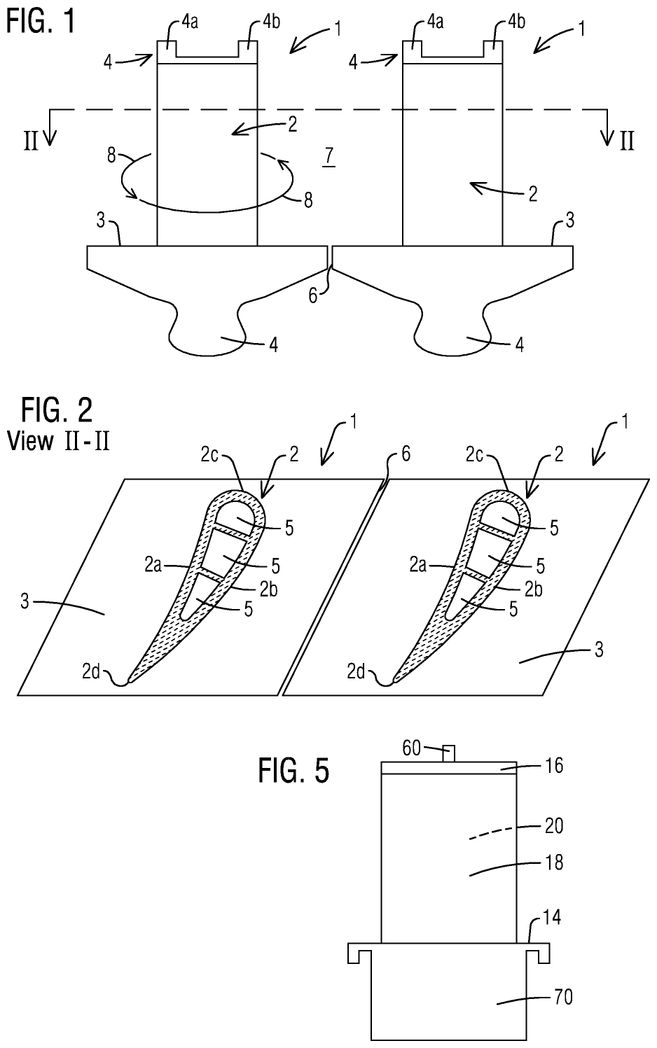

Conventionally, standard rotor blades have been used to extract work from the hot gas in a turbine section of a gas turbine engine. In this context, as shown in FIGS. 1 and 2, a standard rotor blade segment 1 comprises one or more airfoil structures 2 extending span-wise radially outward from a platform 3. Radially inward of the platform 3 is a root portion 4 for attaching the rotor blade segment 1 to a slot on a rotor disc (not shown). As shown in FIG. 2, the airfoil structure 2 is aerodynamically shaped, comprising a pressure sidewall 2a, which may be generally concave, and a suction sidewall 2b, which may be generally convex. The pressure and suction sidewalls 2a, 2b are joined at a leading edge 2c and at a trailing edge 2d of the airfoil structure 2. At a radially outer tip of the airfoil structure 2, a tip feature 4 may be provided, which runs a tight gap with a surrounding stationary component (not shown) for minimizing leakage flow over the airfoil structure 2. In case of a forward rotor stage (e.g., a row 1 or row 2 rotor stage), such a tip feature 4 may be configured as a squealer tip, which essentially comprises one or more tip walls 4a, 4b extending radially outward from the airfoil tip.

Referring to FIG. 2, each airfoil structure 2 typically includes internal cooling channels 5, which may be embodied, for example, as serpentine cooling channels, impingement cavities, among other possible configurations. The cooling channels 5 are supplied with coolant via the root portion 4 (FIG. 1), for example, from a compressor section of the turbine engine. The coolant absorbs heat, particularly from the airfoil outer wall as it traverses the internal cooling channels 5, before being discharged from the airfoil 2 via exhaust orifices (not shown). The rotor blade segments 1 are arranged circumferentially adjacent to each other to form a rotor stage. Circumferentially adjacent rotor blade segments mate along a split-line 6 located at the circumferential mate-face edges of the platforms 3. The split-line 6 is typically located mid-way between adjacent airfoil structures 2. The volume between adjacent airfoils 2 forms an inter airfoil flow passage 7 for the hot gas.

A standard rotor blade segment typically has a metallic construction, being formed, for example, of a superalloy, such as a nickel based superalloy, and coated with a thermal barrier coating. It has been seen that by changing the base material from a nickel based superalloy to a CMC material, it is possible to significantly reduce the coolant air requirements of blade components. As previously stated, the above benefit arises from the fact that a CMC material can typically operate at higher temperatures than nickel based superalloys.

In a CMC blade, each rotor blade segment including the airfoil structure 2, the platform 3 may be formed of a metallic substructure, for example, formed by casting or other processes, over which a CMC material is assembled. The airfoil structure 2 is generally monolithically formed, comprising the pressure sidewall 2a and the suction sidewall 2b. The CMC material may be assembled as a skin over the metallic substructure. Conventionally, the CMC skin is laid-up around the airfoil structure 2 in a direction from the leading edge to the trailing edge (or vice versa), as indicated by the arrow 8 in FIG. 1. By using a CMC material, active cooling requirements may be significantly reduced in forward rotor stages. In some cases, for example, in aft rotor stages, the rotor blade segment may be sufficiently cooled by passive cooling such as radiation and/or natural convection. At such locations, the hot gas is significantly cooler than in the forward stages, whereby it may be possible that the operating temperature of the components is such that a passive cooling may sufficiently cool the components.

It has been seen that although it is fairly straightforward to cast turbine components using the current base materials, manufacturing an airfoil shape out of a CMC material is much more challenging. In addition, it has also been observed that CMC airfoil structures typically tend to have large diameters at the trailing edge, which may negatively affect aerodynamic efficiency of the airfoil. The present inventors have devised a unique configuration for a segment of a turbine rotor stage. Embodiments of the present invention address one or more of the above mentioned technical problems and provide numerous other benefits as described below. An underlying idea herein is a change in paradigm, from a monolithic airfoil structure with pressure and suction sidewalls, to a unitary rotor segment comprising circumferentially spaced first and second sidewalls, whereby the first sidewall of one segment pairs with a second sidewall of an adjacent segment, to form a composite airfoil structure. The end result will still be a circumferential row of airfoil structures as in case of a standard blade assembly. However, instead of having the split-line between adjacent segments extending along the platform mate-face, about mid-way between adjacent airfoils, the split-line in this case would extend through the composite airfoil structure.

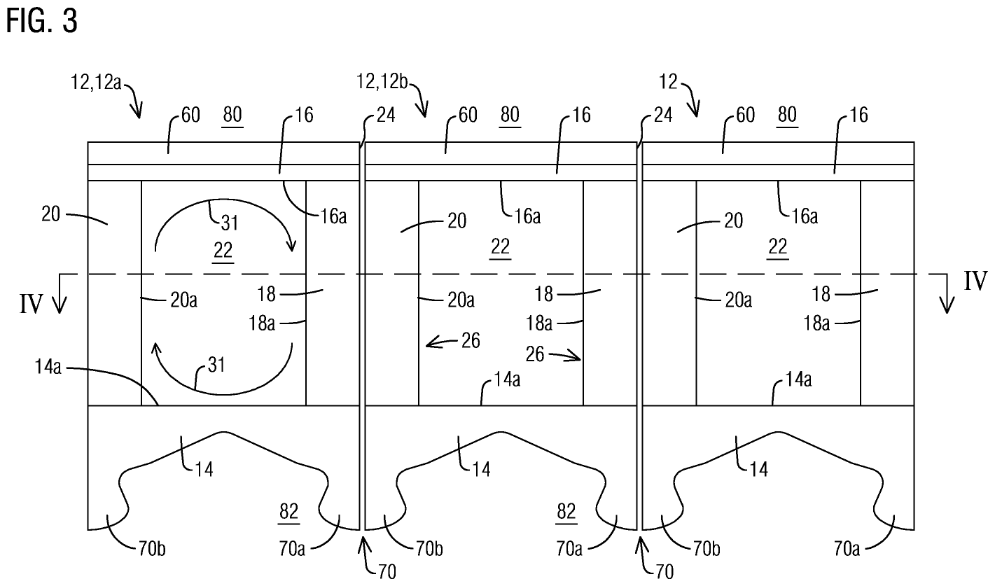

An embodiment of the present invention is now illustrated referring to FIGS. 3-5. As shown, a rotor stage 10 comprises a plurality of discrete segments 12. In the illustrated embodiment, each of the segments 12 is formed, at least in part from a ceramic matrix composite (CMC) material such as, for example but not limited to, an oxide-oxide CMC, a SiC—SiC CMC, among others. As noted above, such materials are known to be operable at higher temperatures than conventional superalloys, which makes it possible to reduce consumption of compressor air for cooling purposes. Each segment 12 includes a first endwall 14 and a second endwall 16 which are spaced in a radial direction of the turbine engine. Each segment 12 further includes a first sidewall 18 and a second sidewall 20 spaced apart in the circumferential direction of the turbine engine. Each segment 12, including the first and second endwalls 14, 16 and the first and second sidewalls 18, 20, defines therewithin a flow passage 22 (see FIG. 3) for hot gas. In relation to the hot gas in the flow passage 22, the first sidewall 18 may define a relatively high pressure surface while the second sidewall 20 may define a relatively low pressure surface. In the illustrated embodiment, the first sidewall 18 is concave while the second sidewall 20 is convex in relation to the hot gas in the flow passage 22. The CMC material may form at least the respective hot gas exposed surfaces 14a, 16a, 18a, 20a (see FIG. 3) respectively of the first and second endwalls 14, 16 and the first and second sidewalls 18, 20 that define the flow passage 22.

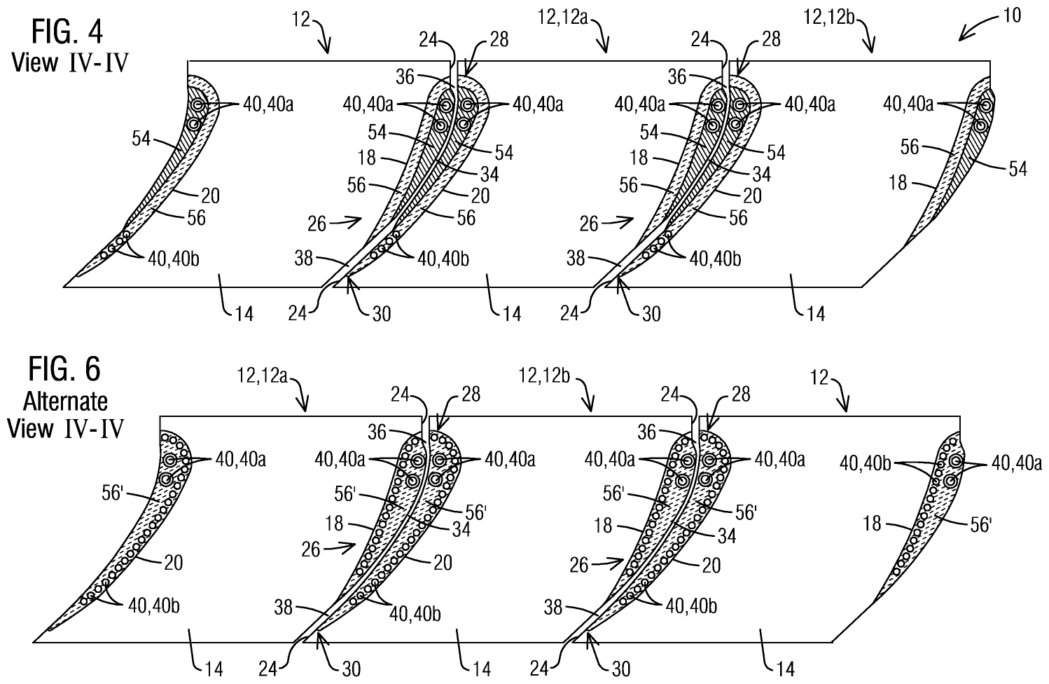

As shown in FIGS. 3 and 4, circumferentially adjacent segments 12a, 12b mate along a respective split-line 24 which extends along an interface between the first sidewall 18 of a first segment 12a and the second sidewall 20 of a second circumferentially adjacent segment 12b. The first and second segments 12a, 12b mate to form a composite airfoil structure 26, which comprises a pressure sidewall 18 formed by the first sidewall 18 of the first segment 12a, and a suction sidewall 20 formed by the suction sidewall 20 of the second segment 12b. The pressure and suction sidewalls 18, 20 of the airfoil structure 26 extend at least partially between a leading edge 28 and a trailing edge 30 of the airfoil structure 26.

The embodiment illustrated in FIGS. 3-5 is thus distinct from a standard rotor blade segment as shown in FIGS. 1-2 which comprises one or more monolithic airfoil structures 2 extending radially from a platform 3. Resultantly, while in a standard rotor blade segment assembly (see FIGS. 1-2), the split-line 7 between a pair of circumferentially adjacent rotor blade segments extends along the mate-face of the platform 3, about mid-way between adjacent airfoils 2, in the illustrated embodiment (see FIGS. 3-5), the split-line 24 extends through the composite airfoil structure 26. The change in approach from forming a monolithic airfoil structure on a platform toward forming a segment with a box type structure defined by first and second endwalls 14, 16 and first and second sidewalls 18, 20 leads to advantages both in terms of aerodynamic performance as well as manufacturability.

A first aerodynamic advantage lies in the fact that the outer endwall 14 may be configured as a tip shroud 14 of the rotating segment, which serves to substantially prevent overtip leakage of the hot gas between the airfoil and the surrounding stationary casing. Such a configuration would enhance aerodynamic performance particularly in forward rotor stages, which are conventionally provided with squealer tips. A second aerodynamic advantage lies in the possibility to reduce the trailing edge thickness of the airfoil structure. This may be achieved by cutting back either the pressure sidewall or the suction sidewall from the trailing edge of the airfoil structure. In the embodiment shown in FIG. 4, the pressure sidewall 18, which is the first sidewall 18 of the first segment 12a, is cutback from the trailing edge 30 of the composite airfoil structure 26, to reduce the trailing edge thickness. A similar effect may be achieved, alternately, by cutting back the suction sidewall 20, which is the second sidewall 20 of the second segment 12b, from the trailing edge 30 of the composite airfoil structure 26. The proposed configuration thus addresses an existing problem with CMC airfoils, which typically tend to have large diameters at the trailing edge, which may negatively affect aerodynamic efficiency of the airfoil. Furthermore, the proposed concept of forming a rotor stage with split-lines through the airfoil structure leads to a significant reduction of the mate-face length along the first and second endwalls 14, 16 that need to be sealed, which helps reduce leakage flow and further drives down coolant consumption in the rotor stage.

In one embodiment, as shown in FIGS. 3 and 5, a stiffening beam 60 may be positioned over the tip shroud 16, extending radially outwardly from the tip shroud 16 and running circumferentially along the tip shroud 16. The beam 60 may serve to support the centrifugal loading induced by the spinning of the box-type segment 12, thus preventing the segment 12 from bowing. In further embodiments, more than one beams 60 may be provided over the tip shroud 16, which may, for example, be offset toward the pressure sidewall 18 and the suction sidewall 20, to prevent leakage around the box-type segments 12.

As shown in FIG. 3, the first endwall 14 is configured as a platform 14 of the segment 12. Radially inward of the platform 14 is a root 70, via which the segment 12 is attachable to a rotor disc (not shown). In the illustrated example, the split-line 24 extends through the root 70. That is, the root 70 is made up of a first root portion 70a formed on the platform 14 of the first segment 12a, which interfaces along the split-line 24 with a second root portion 70b formed on the platform 14 of the second segment 12b. In alternate embodiments, the root 70 may be integrally formed whereby the split-line 24 may extend only through the airfoil structure 24.

From a manufacturing standpoint, an advantage of the proposed configuration lies in the fact that it is no longer necessary to have the CMC material laid-up or assembled around an airfoil structure from the leading edge to the trailing edge as schematically shown by the arrow 8 in FIG. 1, which poses a manufacturing challenge, at least at the junction of the airfoil structure 2 with the platform 3. In contrast to the above configuration, the proposed configuration makes it possible to lay-up plies of the CMC material in a continuous fashion to form a box-structure defining the inner periphery i.e. hot gas exposed surfaces 14a, 16a, 18a, 20a of the segment 12 that define the flow passage 22, as shown schematically by the arrow 31 in FIG. 3. The lay-up sequence may, for example, be in the direction of the arrow 31, i.e., clock-wise from the parts 18 to 14 to 20 to 16, or vice versa. Such a lay-up may be achieved by relatively simple internal tooling means, for example using a negative mold representing the gas path volume of the flow passage 22. The proposed box configuration of allows the segments 12 to be formed by the CMC material in a way that aids manufacturability and longevity.

In one embodiment, each segment 12, including the inner and outer endwalls 14, 16 and the first and second sidewalls 18, 20 comprises a metallic substructure, which may be designed to carry mechanical loads, for example, aerodynamic and/or centrifugal loads, on the segment 12. The metallic substructure may be formed, for example, by casting, or any other process. Subsequently, a CMC skin is assembled over the metallic substructure to define the hot gas exposed surfaces 14a, 16a, 18a, 20a, which form the inner periphery of the segment 12. The CMC skin may be manufactured as a box-structure by laying up plies of CMC material in a continuous fashion as described above, before being assembled over the metallic substructure. In alternate embodiments, instead of using a metallic substructure, one or more of the first and second sidewalls 18, 20 and/or one or more of the first and second endwalls 14, 16 may be formed entirely out of a CMC material with a desired thickness for providing mechanical support to the rotor components. For example, in the embodiment shown in FIG. 4, the first and second sidewalls 18, 20 comprise a metallic substructure or spar 54 over which a CMC skin 56 is assembled. In an alternate embodiment as shown in FIG. 6, the metal spar may be altogether eliminated from the first and second sidewalls 18, 20, which may be entirely formed of a CMC material 56′ having a thickness enough to support the airfoil weight. In both the example embodiments of FIG. 4 and FIG. 6, the first and second endwalls 14, 16 may have a metallic substructure.

The airfoil structure 26 may be provided with internal cooling passages 40, which may be supplied with a coolant, such as air from the compressor section, via the root 70. The passages 40 may comprise span-wise holes through the metallic substructure 54 or the CMC skin 56 through which conduct coolant in a radial direction. In alternate embodiments, one or more of the passages 40 may be formed by inserting coolant tubes through the metallic substructure 54 or the CMC skin 56. The coolant tubes may be configured, for example, as load bearing strut tubes for supporting mechanical loads on the rotor segment 12.

In the example embodiment shown in FIG. 4, the internal cooling passages 40 comprise a first set of coolant passages 40a that may be formed through the metallic substructure 54, and extend in a radial direction from the root 70 toward the tip shroud 16 (see FIG. 3). The coolant flow through the passages 40a provide backside cooling to the CMC skin 56 via conduction through the metallic substructure 54. The coolant traversing the passages 40a may be further utilized in a number of ways. In one example embodiment, the coolant from the passages 40a may be directed radially outboard of the tip shroud 16, to purge the region 80 (see FIG. 3) between the tip shroud 16 and the stationary casing (not shown). In an alternate example embodiment, the coolant from the passages 40a may be routed back in a radially inboard direction to purge a region 82 near the root 70 (see FIG. 3). Additionally and optionally, a second set of coolant passages 40b may be provided through the CMC skin 56 in regions which may not receive backside cooling due to an absence of the metallic substructure 54 in the region. In the embodiment shown in FIG. 4, optional coolant passages 40b may be provided through the suction sidewall 20 near at the trailing edge 30.

In the example embodiment shown in FIG. 6, the coolant passages 40a may serve the same purpose as in FIG. 4. However, due to the absence of the metallic substructure in this configuration, the backside cooling provided by the coolant through the passages 40a may be insufficient due to the strong thermal insulation properties of the CMC material 56′. In this configuration, additional coolant passages 40b may be provided substantially along the periphery of the pressure and suction sidewalls 18, 20 to provide near-wall cooling to the pressure and suction sidewalls 18, 20, as well as for cooling the outer endwall 16 of the segment 12.

In the illustrated embodiments, for example referring to FIG. 4 and FIG. 6, an interface gap is formed along the split-line 24, which defines an internal cavity 34 through the composite airfoil 26. The internal cavity 34 opens into a first gap 36 at the leading edge 28 and a second gap 38 formed at the trailing edge 30.

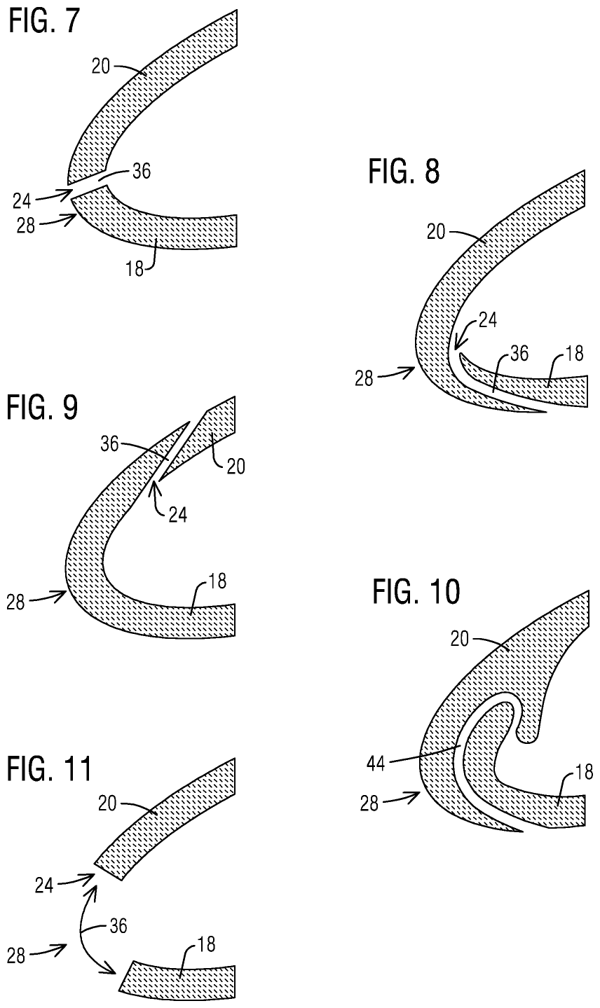

In one embodiment, for example applicable in a forward rotor stage, the leading and trailing edge gaps 36 and 38 may be sealed by pressurizing the internal cavity 34 by a fluid. The pressurizing fluid, which in this example comprises compressed air from the compressor section, may be supplied via the root 70 into the internal cavity 34. The pressure of the pressurizing fluid may be configured so as to maintain a positive outflow margin at the 36, 38 in relation to the hot gas flow external to the airfoil structure 26, to thereby prevent an ingestion of the hot gas into the internal cavity 34. To this end, the interface between the pressure and suction sidewalls 18, 20 may be suitably configured to provide effective sealing at the leading and trailing edge gaps (see FIGS. 7-10). Pressurized air, which exits the gaps 36, 38 at the leading and trailing edge interfaces may offer cooling benefits to those regions in the form of backside cooling as well as film cooling.

In an alternate embodiment, for example applicable in an aft rotor stage, the gaps 36, 38 at the leading edge 28 and the trailing edge 30 may allow hot gas ingestion into the internal cavity 34 of the airfoil structure 26. By allowing the hot gas to travel though the airfoil 26 by entering at the stagnation region at the leading edge 28 and exiting at the trailing edge cutback, it is ensured that wakes produced by the airfoil structure 26 are filled by the ingested hot gas. Furthermore, the hot gas ingestion would also help reduce thermal fight in the airfoil structure 26 as both the “hot” and “cold” side of both the CMC sidewalls 18, 20 will now be exposed to the hot gas. Additional cooling benefits may be realized through such leakages in the form of backside cooling as well as film cooling.

FIGS. 7-11 illustrate multiple embodiments of the present invention depicting different configurations of the split-line between circumferentially adjacent segments. FIG. 7 illustrates an embodiment in which the split-line 24 extends along a mean camber line of the airfoil structure 26, forming a small gap 36 located at the center of the leading edge 28. In alternate embodiments, the split-line 24 may be offset from the mean camber line of the airfoil structure 26 toward the pressure sidewall 18 (FIG. 8) or toward the suction sidewall 20 of the airfoil structure 26 (FIG. 9). As a result, the gap 36 at the leading edge 28 would be correspondingly offset toward the pressure sidewall 18 or the suction sidewall 20 of the airfoil structure 26. The embodiment of FIGS. 8 and 9 provide that the split plane is shifted from the stagnation point at the leading edge, which minimizes hot has ingestion through the interface gap 36 at the leading edge 28. In yet another embodiment as illustrated in FIG. 10, the split-line interface at the leading edge 28 may include a ship-lapped interface 44. Such a ship-lapped or interlocking interface 44 serves to discourage through flow of hot gas and thereby acts as a sealing mechanism against hot gas ingestion. An alternate embodiment is illustrated in FIG. 11, in which the gap 36 at the leading edge 28 may be designed to be large enough to encourage through flow of hot gas into the airfoil structure 26 (in contrast to FIG. 7), such as, for example, in an aft rotor stage. In this case, the gap 36 may preferably cover the stagnation point at the leading edge 28 to aid hot gas ingestion.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. A rotor stage of a turbine engine, comprising:
a circumferential row of rotor segments, each segment comprising:
first and second endwalls extending in a circumferential direction and spaced apart in a radial direction in relation to an axis of the turbine engine, the first endwall configured as a platform and the second endwall configured as a tip shroud of the segment, and
first and second sidewalls spaced apart in the circumferential direction and extending radially between the first and second endwalls,
wherein the first and second endwalls and the first and second sidewalls define therewithin a flow passage for a hot gas,
wherein circumferentially adjacent segments mate along a respective split-line which extends along an interface between the first sidewall of a first segment and the second sidewall of a second circumferentially adjacent segment, to form composite airfoil structure which comprises:
a pressure sidewall formed by the first sidewall of the first segment and a suction sidewall formed by the second sidewall of the second segment the pressure and suction sidewalls of the airfoil structure extending between a leading edge and a trailing edge of the airfoil structure.

2. The rotor stage according to claim 1, wherein at least one of the segments is formed at least in part from a ceramic matrix composite material.

3. The rotor stage according to claim 2, wherein the ceramic matrix composite material forms respective hot gas exposed surfaces of the first and second endwalls and the first and second sidewalls that define the flow passage of the segment.

4. The rotor stage according to claim 3, wherein at least a portion of the segment comprises metallic substructure over which a skin made up of the ceramic matrix composite material is assembled to form the hot gas exposed surfaces of the segment.

5. The rotor stage according to claim 4, wherein at least the first and second sidewalls are entirely formed of the ceramic matrix composite material.

6. The rotor stage according to claim 3, wherein said hot gas exposed surfaces of the segment are formed by a continuous lay-up of the ceramic matrix composite material along an inner periphery of the segment which defines a boundary of a gas path volume of the flow path.

7. The rotor stage according to claim 1, further comprising one or more stiffening beams extending radially outwardly from the tip shroud and running circumferentially along the tip shroud.

8. The rotor stage according to claim 1, wherein the segment is attachable to a rotor disc via a root,
wherein the split-line extends through the root,
wherein the root comprises a first root portion formed on the first endwall of the first segment and a second root portion formed on the first endwall of the second segment.

9. The rotor stage according to claim 1, wherein either one the pressure sidewall or the suction sidewall of the airfoil structure is cutback from the trailing edge.

10. The rotor stage according to claim 1, wherein the split-line extends along a mean camber line of the airfoil structure (26).

11. The rotor stage according to claim 1, wherein the airfoil structure comprises an internal cavity defined between the pressure sidewall and the suction sidewall.

12. The rotor stage according to claim 11, wherein the airfoil structure comprises a first gap at the leading edge and a second gap at the trailing edge, the first and second gaps being formed along a split-line interface of the pressure sidewall and the suction sidewall.

13. The rotor stage according to claim 12, wherein the split-line is offset from a mean camber line of the airfoil structure toward the pressure sidewall or the suction sidewall of the airfoil structure, such that the first gap-and the second gap are correspondingly offset toward the pressure sidewall or the suction sidewalk of the airfoil structure.

14. The rotor stage according to claim 12, wherein the split-line interface at the leading edge and/or at the trailing edge includes a ship-lapped interface.

15. The rotor stage according to claim 12, wherein the internal cavity of the airfoil structure is pressurized by a fluid to maintain a positive outflow margin at the first and second gaps in relation to a hot gas flow external to the airfoil structure.

16. The rotor stage according to 12, further comprising radially extending coolant passages through the pressure sidewall and/or the suction sidewall of the airfoil structure, for conducting coolant between the first and second endwalls.

17. The rotor stage according to claim 16, wherein the coolant passages are formed through the ceramic matrix composite material.

18. The rotor stage according to claim 16, wherein the coolant passages are formed through a metallic substructure of the pressure sidewall and/or the suction sidewall.

19. The rotor stage according to claim 12, wherein the first and second gaps are configured to allow hot gas ingestion into the internal cavity of the airfoil structure.

20. A segment for a turbine rotor stage, comprising:
first and second endwalls extending in a circumferential direction and spaced apart in a radial direction in relation to an axis of the turbine engine, the first endwall configured as a platform and the second endwall configured as a tip shroud of the segment, and
first and second sidewalls spaced apart in the circumferential direction and extending radially between the first and second endwalls,
wherein the first and second endwalls and the first and second sidewalls define therewithin a flow passage for a hot gas, and
wherein the respective segment is configured to mate with circumferentially adjacent segment on either side along a respective split line, such that each split-line-extends along an interface between one of the first or second sidewalls it of the respective segment and a corresponding other of the first or second sidewalls of the circumferentially adjacent segment on either side.
